(19) United States
(12) Patent Application Publication
(10) Pub. No.: US 2020/0079601 A1
(43) Pub. Date: Mar. 12, 2020

(54) Train Load-Out Arrangement

(71) Applicant: DER-CHANG JOHN LEE ATF IKHTHUS TRUST, Willetton (AU)

(72) Inventor: Der-Chang John LEE, Willetton (AU)

(73) Assignee: DER-CHANG JOHN LEE ATF IKHTHUS TRUST, Willetton (AU)

(21) Appl. No.: 16/613,772

(22) PCT Filed: Apr. 16, 2018
(86) PCT No.: PCT/AU2018/050341

§ 371 Date: Nov. 14, 2019

(30) Foreign Application Priority Data
May 26, 2017 (AU) 2017902013

(51) Int. Cl. B65G 65/00; B65G 67/04; B65G 3/04; G01G 19/04

(52) U.S. Cl. CPC B65G 65/005; B65G 67/04; B65G 3/04; G01G 19/04; B65G 2814/0347; B65G 2814/0302; B65G 2814/0323; B65G 2814/0344; B65G 2201/045

(57) ABSTRACT

A train load-out arrangement having a hopper for operatively containing particulate material and includes a discharge chute with a controllable gate or valve via which the material is operatively dischargeable into ore wagons of a rail. The arrangement includes a first track scale arranged on the track distal from the discharge chute, as well as a second track scale arranged on the track directly underneath the discharge chute. Arrangement also includes a controller arranged in signal communication with the gate and track scales and configured to determine a first wagon axle weight-displacement profile via the first track scale and a second wagon axle weight-displacement profile via the second track scale as material is discharged into a wagon, and compare said first and second wagon axle weight-displacement profiles to produce a real-time noise-compensated wagon axle weight-displacement profile.

### TECHNICAL FIELD

This invention relates to the field of loading particulate material into rail wagons, in general, and more specifically to a train load-out arrangement, a controller for a train load-out arrangement and an associated method for loading a train consist with particulate material.

### BACKGROUND ART

The following discussion of the background art is intended to facilitate an understanding of the present invention only. The discussion is not an acknowledgement or admission that any of the material referred to is or was part of the common general knowledge as at the priority date of the application.

Various production and industrial processes involve the loading of particulate or granular matter or material into receptacles or containers. For example, in the mining industry, mined ore is loaded into ore wagons for transport purposes. Correct loading of such ore wagons is generally necessary to ensure that ore wagons are not overloaded and/or material loss does not occur during subsequent rail transport. At the same time, proper loading is necessary to ensure that a maximum amount of ore is loaded into each wagon to allow for efficient transport thereof.

Overloading of ore wagons can place unwanted stress on critical components which can lead to failures and even train derailments. On the other hand, under-loaded ore wagons represent wasted rail capacity and poor network efficiency.

The loading of ore wagons is typically performed by means of a train load-out (TLO) installation, generally comprising some manner of conveyor system feeding a bin or hopper with material and a discharge chute via which the material is discharged from the bin or hopper into each ore wagon, typically under the influence of gravity, as the train consist, generally consisting of one or several locomotives and ore wagons, passes on a track underneath the TLO installation.

The flow of material from the TLO is typically controlled by means of a knife gate or a clamshell gate to regulate the flow of material from the bin or hopper into the ore wagons. In practice, a train consist is made to pass underneath the TLO and the gate is controlled to open at an appropriate time so that material passes into each wagon via the discharge chute.

In order to enable correct loading of such ore wagons, control systems are used whereby weight sensors generally measure the weight of each ore wagon before and after the loading process. In general, weight sensors are installed 20 to 30 meters before and after where the TLO discharges the ore into a wagon. One of the reasons for this is to avoid dynamic noise resulting from the loading process, where ore dropping or falling into a wagon is generally disruptive and produces dynamic signal noise leading to incorrect weight measurements. The force of ore dropping into a wagon, the potential energy of material in the bin or hopper, ore density and interaction forces in-between wagons all present dynamic noise sources that may lead to incorrect wagon weight measurement.

Due to the known systems only measuring wagon weight before and after the TLO, such control systems typically require advanced configurations to achieve some level of loading accuracy, as it is generally not possible to easily add or remove material after a wagon is loaded. As the known control systems use indirect weight measurements, they need to rely on assumption based on estimation of various parameters, such as material properties, material flow rate, etc. Once an ore wagon is at the specified estimated full-load weight, the flow of material into the wagon is stopped by shutting the gate.

However, there are several shortcomings associated with the known TLO control systems, such as the actual weight of each loaded wagon being unknown until it reaches the load cell or track scale location following the TLO, the control system being unable to adjust the gate in a timely and accurate manner because it is based on the parameters of previous wagons, indirect measurements and assumptions, and the control system being unable to respond to changing material characteristics, such as density, moisture content, particle size and temperature that impact the material flow characteristics. Such parameters typically require ongoing manual adjustment of the control system when loading circumstances change.

Accordingly, Applicant has identified a need in the art for a TLO control system that does not rely on such reactive operation where manual input is required when loading circumstances change. The known control systems are generally unable to respond to changing material characteristics, such as moisture content, particle size, temperature, etc. For example, weight is not an accurate representation of material volume, as the same type of material may have different volumes at various levels of moisture content. Similarly, if ore moisture content changes, ore flow may speed up or slow down resulting in under-loading or overloading of the wagons. As a result, changes in material characteristics may easily lead to under-loading or overloading.

The current invention was conceived with these shortcomings in mind in an attempt to ameliorate, at least in part, some of the shortcomings in the field of loading particulate matter into rail wagons.

### SUMMARY OF THE INVENTION

It is to be appreciated that reference herein to ‘real-time’ is to be understood as meaning an instance of time that may include a delay typically resulting from processing, calculation and/or transmission times inherent in processing or computer systems. These transmission and calculations times, albeit of generally small duration, do introduce some delay, i.e. typically within a period in the order of micro or milliseconds generally imperceptible to a human being who experiences such occurrences in ‘real-time’.

According to a first aspect of the invention there is provided a train load-out arrangement comprising:

a hopper operatively containing particulate material and having a discharge chute with controllable gate via which the material is operatively dischargeable into ore wagons of a rail consist passing beneath said chute on a rail track;

a first track scale arranged on the track distal from the discharge chute;

a second track scale arranged on the track underneath the discharge chute; and a controller arranged in signal communication with the gate and track scales and configured to, as the consist passes along the track:
i. determine a first wagon axle weight-displacement profile via the first track scale;
ii. determine a second wagon axle weight-displacement profile via the second track scale as material is discharged into a wagon;
iii. compare said first and second wagon axle weight-displacement profiles to produce a real-time noise-compensated wagon axle weight-displacement profile; and
iv. control the gate in accordance with the noise-compensated wagon axle weight-displacement profile to regulate real-time material discharge into a wagon;

wherein loading of a wagon with a desired weight of particulate material is facilitated according to real-time direct weight measurement underneath said chute.

Typically, a track scale comprises at least one strain gauge fitted to the track.

In an embodiment, the track scale comprises a plurality of strain gauges fitted over a portion of the track.

In an embodiment, a plurality of strain gauges is grouped together to the track to form a strain gauge grouping, each strain gauge in a grouping arranged at a predetermined angle and orientation to each other.

In an embodiment, the strain gauge grouping comprises a rosette strain gauge configuration.

Typically, the controller is configured to determine a wagon axle weight-displacement profile from a strain gauge grouping using measurements from each according to the predetermined angle and orientation of such grouping.

In an embodiment, the controller includes a wagon speed sensor for sensing a speed of the wagons on the track.

In an embodiment, the controller is configured to determine a wagon axle weight-displacement profile from a moment of sensing a wagon via a track scale in combination with time elapsed and a measured speed of said wagon.

Typically, a wagon axle weight-displacement profile comprises a relationship between wagon axle weight and displacement along the track.

In an embodiment, the first track scale is arranged a predetermined distance before the discharge chute.

In an embodiment, the predetermined distance is between 10 m and 50 m.

In an embodiment, the first track scale is arranged a predetermined distance after the discharge chute.

In an embodiment, the predetermined distance is between 10 m and 50m.

Typically, the controller compares the first and second wagon axle weight-displacement profiles to produce a real-time noise-compensated wagon axle weight-displacement profile by subtracting noise-induced discrepancies in the first profile from the second profile in real-time, so that the noise-compensated profile provide a real-time indication of wagon weight.

In an embodiment, the controller includes a wagon axle position sensor for detecting a wagon axle position for tracking wagon movement across the track scale.

In an embodiment, the wagon axle position sensor is selected from a group consisting of a photo-electronic sensor, an inductive wheel sensor, a laser-based position sensor, and an ultrasonic-based position sensor.

Typically, the controller includes a level sensor configured to measure a level of material in the hopper.

Typically, the level sensor is selected from a group consisting of a load cell, a laser distance sensor, an ultrasound distance sensor, and a radar distance sensor.

Typically, the controller includes a density sensor configured to measure ore density of material in the hopper.

According to a second aspect of the invention there is provided a controller for a train load-out arrangement having a hopper operatively containing particulate material and having a discharge chute with controllable gate via which the material is operatively dischargeable into ore wagons of a rail consist passing beneath said chute on a rail track, as well as a first track scale arranged on the track distal from the discharge chute and a second track scale arranged on the track underneath the discharge chute, said controller arranged in signal communication with the gate and track scales and configured to, as the consist passes along the track:
i. determine a first wagon axle weight-displacement profile via the first track scale;
ii. determine a second wagon axle weight-displacement profile via the second track scale as material is discharged into a wagon;
iii. compare said first and second wagon axle weight-displacement profiles to produce a real-time noise-compensated wagon axle weight-displacement profile; and
iv. control the gate in accordance with the noise-compensated wagon axle weight-displacement profile to regulate real-time material discharge into a wagon;

wherein loading of a wagon with a desired weight of particulate material is facilitated according to real-time direct weight measurement underneath said chute.

Typically, the controller is configured to determine a wagon axle weight-displacement profile from a strain gauge grouping using measurements from each according to the predetermined angle and orientation of such grouping.

In an embodiment, the controller includes a wagon speed sensor for sensing a speed of the wagons on the track.

In an embodiment, the controller is configured to determine a wagon axle weight-displacement profile from a moment of sensing a wagon via a track scale in combination with time elapsed and a measured speed of said wagon.

Typically, a wagon axle weight-displacement profile comprises a relationship between wagon axle weight and displacement along the track.

Typically, the controller compares the first and second wagon axle weight-displacement profiles to produce a real-time noise-compensated wagon axle weight-displacement profile by subtracting noise-induced discrepancies in the first profile from the second profile in real-time, so that the noise-compensated profile provide a real-time indication of wagon weight.

In an embodiment, the controller includes a wagon axle position sensor for detecting a wagon axle position for tracking wagon movement across the track scale.

In an embodiment, the wagon axle position sensor is selected from a group consisting of a photo-electronic sensor, an inductive wheel sensor, a laser-based position sensor, and an ultrasonic-based position sensor.

Typically, the controller includes a level sensor configured to measure a level of material in the hopper.

Typically, the level sensor is selected from a group consisting of a load cell, a laser distance sensor, an ultrasound distance sensor, and a radar distance sensor.

Typically, the controller includes a density sensor configured to measure ore density of material in the hopper.

According to a third aspect of the invention there is provided a method for loading a train consist with particulate material, said method comprising the steps of:

passing said rail consist on a rail track beneath a hopper containing particulate material and having a discharge chute with controllable gate via which the material is operatively dischargeable into ore wagons of said consist, the rail track having a first track scale arranged on the track distal from the discharge chute and a second track scale arranged on the track underneath the discharge chute;

determining, via a controller arranged in signal communication with the gate and track scales, as the consist passes along the track, a first wagon axle weight-displacement profile via the first track scale and a second wagon axle weight-displacement profile via the second track scale as material is discharged into a wagon;

comparing, via the controller, said first and second wagon axle weight-displacement profiles to produce a real-time noise-compensated wagon axle weight-displacement profile; and

controlling the gate in accordance with the noise-compensated wagon axle weight-displacement profile to regulate real-time material discharge into a wagon, wherein loading of a wagon with a desired weight of particulate material is facilitated according to real-time direct weight measurement underneath said chute.

Typically, the step of determining a wagon axle weight-displacement profile is performed from a strain gauge grouping using measurements from each according to the predetermined angle and orientation of such grouping.

In an embodiment, the step of determining a wagon axle weight-displacement profile is performed from a moment of sensing a wagon via a track scale in combination with time elapsed and a measured speed of said wagon.

Typically, the step of determining a wagon axle weight-displacement profile comprises establishing a relationship between wagon axle weight and displacement along the track.

Typically, the step of comparing the first and second wagon axle weight-displacement profiles to produce a real-time noise-compensated wagon axle weight-displacement profile is performed by subtracting noise-induced discrepancies in the first profile from the second profile in real-time, so that the noise-compensated profile provide a real-time indication of wagon weight.

### BRIEF DESCRIPTION OF THE DRAWINGS

The description will be made with reference to the accompanying drawings in which:

FIG. 1 is a diagrammatic perspective-view representation of an embodiment of a train load-out arrangement in accordance with an aspect of the invention; and

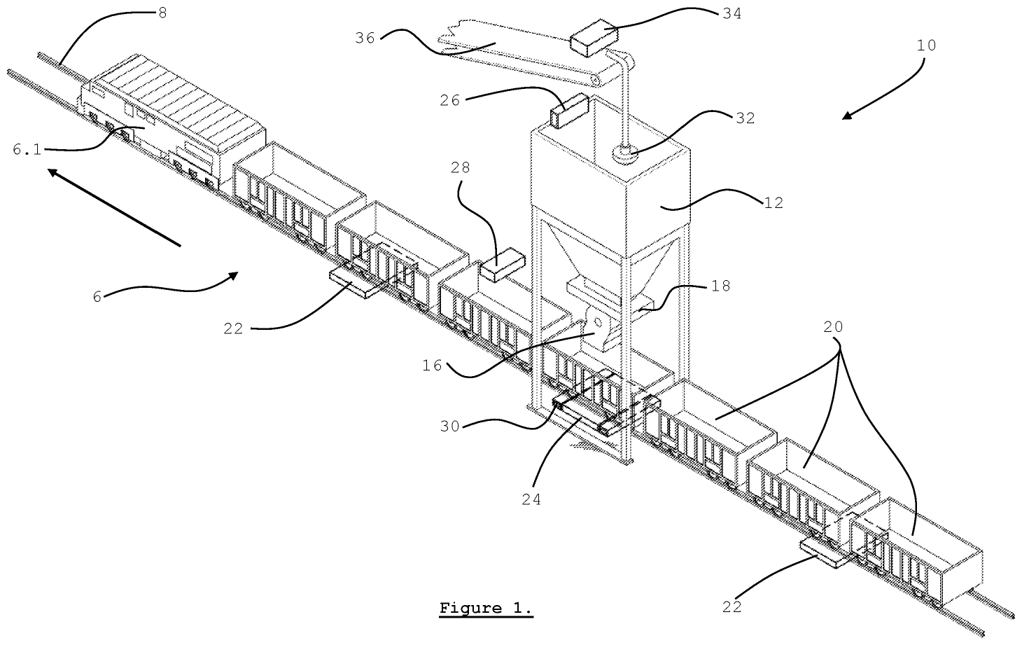

FIG. 2 is a diagrammatic side-view representation of the train load-out arrangement of FIG. 1, during loading of a train consist with particulate material.

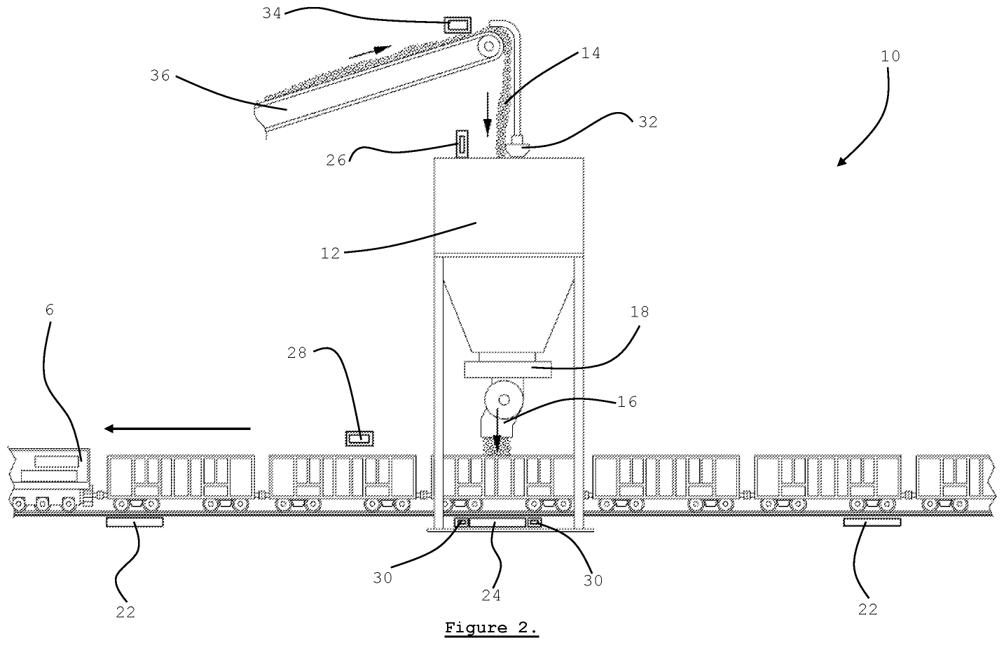

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

Referring now to the accompanying drawings, there is shown one embodiment of a train load-out arrangement 10, which generally comprises a hopper 12 for operatively containing particulate material 14 and includes a discharge chute 16 with a controllable gate or valve 18 via which the material 14 is operatively dischargeable into ore wagons 20 of a rail consist 6 passing beneath the chute 16 on a rail track 8, as shown. The consist 6 generally includes one or more locomotives 6.1 for pulling or drawing the ore wagons 20, with a direction of travel as indicated. Hopper 12 is typically supplied with material 14 via a conveyor 36, but other arrangements are possible and within the scope of the present invention.

The arrangement 10 further includes a first track scale 22 arranged on the track 8 distal from the discharge chute 16, as well as a second track scale 24 arranged on the track 8 directly underneath the discharge chute 16, as shown. It is to be appreciated that the first track scale 22 may be before and/or after the discharge chute 16. In addition, the skilled addressee will appreciate that reference to ‘on the track’ may include underneath, next to, proximate, etc., or any suitable arrangement that allows for measuring or determining weight aspects of the ore wagons 20.

Arrangement 10 also includes a controller 26 arranged in signal communication with the gate 18 and track scales 22 and 24. The skilled addressee will appreciate that such a controller 26 is typically situated in a remote control room, but is diagrammatically indicated by component 26 for the sake of exemplifying the present embodiment.

The controller 26 is generally configured to, as the consist 6 passes along the track 8, determine a first wagon axle weight-displacement profile via the first track scale 22, determine a second wagon axle weight-displacement profile via the second track scale 24 as material 14 is discharged into a wagon 20, and compare said first and second wagon axle weight-displacement profiles to produce a real-time noise-compensated wagon axle weight-displacement profile.

The controller 26 then typically controls the gate in accordance with this noise-compensated wagon axle weight-displacement profile to regulate real-time material discharge into a wagon 20. In such a manner, loading of an ore wagon 20 with a desired weight of particulate material 14 is facilitated according to real-time direct weight measurement underneath said chute 16, rather than assumptions based on earlier and later wagon weight measurements, as is done in the art.

In one example, the track scale 22 and 24 comprises at least one strain gauge fitted to the track 8, as in known in the art. In an embodiment, the track scale 22 and 24 comprises a plurality of strain gauges fitted over a portion of the track 8. In one example, a plurality of strain gauges is grouped together to the track 8 to form a strain gauge grouping, each strain gauge in a grouping arranged at a predetermined angle and orientation to each other. For example, in an embodiment, the strain gauge grouping comprises a rosette strain gauge configuration, or the like.

The skilled addressee will appreciate that the track scale 22 and/or 24 may comprise a plurality of strain gauges fitted over a portion of the track 8, where such portion can include varying lengths along the track 8. In one embodiment, a track scale is distributed along a track portion to measure wagon weight across an entire ‘impacting zone’ underneath the chute 16, e.g. the same of longer length of a wagon. This typically enables tracking of whole wagon weight from a start of loading at a first wagon bogie to an end of a last wagon bogie, or the like, allowing more time for the controller 26 to measure and react accordingly. Similarly, a shorter track scale portion would reduce overall costs, but provide less time for the controller 26 to measure and react. Typically, track scale portion length may influence a resolution of the resulting wagon axle weight-displacement profile.

The controller 26 is typically configured to determine a wagon axle weight-displacement profile from such a strain gauge grouping using measurements from each strain gauge according to the predetermined angle and orientation of such grouping.

In another embodiment, the controller 26 includes a wagon speed sensor 28 for sensing a speed of the wagons 20 on the track 8. In such an embodiment, the controller 26 is generally configured to determine a wagon axle weight-displacement profile from a moment of sensing a wagon via a track scale, typically the second track scale 24, but the first track scale 22 is also apposite, in combination with time elapsed and a measured speed of said wagon. The skilled addressee will appreciate that a wagon axle weight-displacement profile typically comprises a relationship between wagon axle weight and displacement along the track 8.

In an embodiment, the first track scale 22 is arranged a predetermined distance before and/or after the discharge chute 16. In a typical example, this predetermined distance is between 10 m and 50 m, but other distances may be used with similar results.

In an example, the controller 26 typically compares the first and second wagon axle weight-displacement profiles to produce the real-time noise-compensated wagon axle weight-displacement profile by subtracting noise-induced discrepancies in the first profile from the second profile in real-time, so that the noise-compensated profile provides a real-time indication of wagon weight during loading thereof.

In one embodiment, the controller 26 also includes a wagon axle position sensor 30 for detecting a wagon axle position for tracking wagon movement across the track scale 22 and/or 24. In an example, the wagon axle position sensor 30 is selected from a group consisting of a photo-electronic sensor, an inductive wheel sensor, a laser-based position sensor, and an ultrasonic-based position sensor, but other sensors may be used.

The controller 26 may also include a level sensor 32 configured to measure a level of material in the hopper 12. Typically, the level sensor 32 is selected from a group consisting of a load cell, a laser distance sensor, an ultrasound distance sensor, and a radar distance sensor, but other level sensor may be used. The controller 26 may also include a density sensor 34 configured to measure ore density of material 14 in the hopper 12, or the like. The application of such measured axle position, material level, and material density is known in the art of TLO controllers and will not be described in detail herein.

As is understood in the field on control engineering, the controller 26 may include any suitable central processing unit or units configured for executing predetermined algorithms or instruction sets to remove or minimise the impact of external dynamic forces or static noises. This includes forces such as gravity from ore being discharged into the wagons, pulling forces from wagon interaction or any other known external forces. The controller 26 receives the track scale and related sensor inputs to calculate preferred gate 18 positions for loading the ore wagons 20. The controller 26 typically includes an arithmetic logic unit and related memory registers. The controller 26 may also include accessible memory for storing instructions pertaining to the predetermined algorithm, look-up tables of preferred gate positions based on sensor inputs, gate control instructions, and/or the like.

The skilled addressee will further appreciate that the present invention includes an associated method for loading a train consist with particulate material. Such a method generally comprises the steps of passing the rail consist 6 on the rail track 8 beneath the TLO hopper 12 containing the particulate material 14 with the described arrangement 10 in place, determining, via the controller 26, a first wagon axle weight-displacement profile via the first track scale and a second wagon axle weight-displacement profile via the second track scale as material is discharged into a wagon; comparing, via the controller 26, the first and second wagon axle weight-displacement profiles to produce a real-time noise-compensated wagon axle weight-displacement profile; and controlling the gate 18 in accordance with the noise-compensated wagon axle weight-displacement profile to regulate real-time material discharge into a wagon.

Applicant believes is particularly advantageous that the present invention provides for an arrangement 10 whereby direct and real-time ore wagon weight measurement is possible during loading of such a wagon, generally allowing for accurate loading of ore wagons.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1-35. (canceled)

36. A train load-out arrangement comprising:
a hopper operatively containing particulate material and having a discharge chute with controllable gate via which the material is operatively dischargeable into ore wagons of a rail consist passing beneath said chute on a rail track;
a first track scale arranged on the track distal from the discharge chute;
a second track scale arranged on the track underneath the discharge chute; and
a controller arranged in signal communication with the gate and track scales and configured to, as the consist passes along the track:
i. determine a first wagon axle weight-displacement profile via the first track scale;
ii. determine a second wagon axle weight-displacement profile via the second track scale as material is discharged into a wagon;
iii. compare said first and second wagon axle weight-displacement profiles to produce a real-time noise-compensated wagon axle weight-displacement profile; and
iv. control the gate in accordance with the noise-compensated wagon axle weight-displacement profile to regulate real-time material discharge into a wagon;
wherein loading of a wagon with a desired weight of particulate material is facilitated according to real-time direct weight measurement underneath said chute.

37. The arrangement of claim 1, wherein a track scale comprises at least one strain gauge fitted to the track, wherein the track scale comprises a plurality of strain gauges fitted over a portion of the track.

38. The arrangement of claim 36, wherein the controller is configured to determine a wagon axle weight-displacement profile from a strain gauge grouping using measurements from each according to the predetermined angle and orientation of such grouping.

39. The arrangement of claim 36, wherein the controller includes a wagon speed sensor for sensing a speed of the wagons on the track, wherein the controller is configured to determine a wagon axle weight-displacement profile from a moment of sensing a wagon via a track scale in combination with time elapsed and a measured speed of said wagon.

40. The arrangement of claim 36, wherein the first track scale is arranged a predetermined distance of between 10 m and 50 before or after the discharge chute.

41. The arrangement of any of the preceding claims, wherein the controller compares the first and second wagon axle weight-displacement profiles to produce a real-time noise-compensated wagon axle weight-displacement profile by subtracting noise-induced discrepancies in the first profile from the second profile in real-time, so that the noise-compensated profile provides a real-time indication of wagon weight.

42. The arrangement of claim 36, wherein the controller includes a wagon axle position sensor for detecting a wagon axle position for tracking wagon movement across the track scale, said wagon axle position sensor is selected from a group consisting of a photo-electronic sensor, an inductive wheel sensor, a laser-based position sensor, and an ultrasonic-based position sensor.

43. The arrangement of claim 36, wherein the controller includes a level sensor configured to measure a level of material in the hopper, said level sensor is selected from a group consisting of a load cell, a laser distance sensor, an ultrasound distance sensor, and a radar distance sensor.

44. The arrangement of claim 36, wherein the controller includes a density sensor configured to measure ore density of material in the hopper.

45. A controller for a train load-out arrangement having a hopper operatively containing particulate material and having a discharge chute with controllable gate via which the material is operatively dischargeable into ore wagons of a rail consist passing beneath said chute on a rail track, as well as a first track scale arranged on the track distal from the discharge chute and a second track scale arranged on the track underneath the discharge chute, said controller arranged in signal communication with the gate and track scales and configured to, as the consist passes along the track:
i. determine a first wagon axle weight-displacement profile via the first track scale;
ii. determine a second wagon axle weight-displacement profile via the second track scale as material is discharged into a wagon;
iii. compare said first and second wagon axle weight-displacement profiles to produce a realtime noise-compensated wagon axle weight-displacement profile; and
iv. control the gate in accordance with the noise-compensated wagon axle weight-displacement-profile to regulate real-time material discharge into a wagon;
wherein loading of a wagon with a desired weight of particulate material is facilitated according to real-time direct weight measurement underneath said chute.

46. The controller of claim 45, wherein the controller is configured to determine a wagon axle weight-displacement profile from a strain gauge grouping using measurements from each according to the predetermined angle and orientation of such grouping.

47. The controller of claim 45, wherein the controller includes a wagon speed sensor for sensing a speed of the wagons on the track, said controller is configured to determine a wagon axle weight-displacement profile from a moment of sensing a wagon via a track scale in combination with time elapsed and a measured speed of said wagon.

48. The controller of claim 45, wherein the controller compares the first and second wagon axle weight-displacement profiles to produce a real-time noise-compensated wagon axle weight-displacement profile by subtracting noise-induced discrepancies in the first profile from the second profile in real-time, so that the noise-compensated profile provide a real-time indication of wagon weight.

49. The controller of claim 45, wherein the controller includes a wagon axle position sensor for detecting a wagon axle position for tracking wagon movement across the track scale, said wagon axle position sensor selected from a group consisting of a photo-electronic sensor, an inductive wheel sensor, a laser-based position sensor, and an ultrasonic-based position sensor.

50. The controller of claim 45, wherein the controller includes a level sensor configured to measure a level of material in the hopper, said level sensor selected from a group consisting of a load cell, a laser distance sensor, an ultrasound distance sensor, and a radar distance sensor.

51. The controller of claim 45, wherein the controller includes a density sensor configured to measure ore density of material in the hopper.

52. A method for loading a train consist with particulate material, said method comprising the steps of: passing said rail consist on a rail track beneath a hopper containing particulate material and having a discharge chute with controllable gate via which the material is operatively dischargeable into ore wagons of said consist, the rail track having a first track scale arranged on the track distal from the discharge chute and a second track scale arranged on the track underneath the discharge chute;
determining, via a controller arranged in signal communication with the gate and track scales, as the consist passes along the track, a first wagon axle weight-displacement profile via the first track scale and a second wagon axle weight-displacement profile via the second track scale as material is discharged into a wagon;
comparing, via the controller, said first and second wagon axle weight-displacement profiles to produce a real-time noise-compensated wagon axle weight-displacement profile; and controlling the gate in accordance with the noise-compensated wagon axle weight-displacement profile to regulate real-time material discharge into a wagon, wherein loading of a wagon with a desired weight of particulate material is facilitated according to real-time direct weight measurement underneath said chute.

53. The method of claim 52, wherein the step of determining a wagon axle weight-displacement profile is performed from a strain gauge grouping using measurements from each according to the predetermined angle and orientation of such grouping.

54. The method of claim 52, wherein the step of determining a wagon axle weight-displacement profile is performed from a moment of sensing a wagon via a track scale in combination with time elapsed and a measured speed of said wagon.

55. The method of claim 52, wherein the step of comparing the first and second wagon axle weight-displacement profiles to produce a real-time noise-compensated wagon axle weight-displacement profile is performed by subtracting noise-induced discrepancies in the first profile from the second profile in real-time, so that the noise-compensated profile provide a real-time indication of wagon weight.
